(19) United States
(12) Patent Application Publication
(10) Pub. No.: US 2021/0287185 A1
(43) Pub. Date: Sep. 16, 2021

(54) System and Method for Managing Coded Wrapping Paper

(71) Applicant: Taro YAGUCHI, Tokyo (JP)

(72) Inventor: Taro YAGUCHI, Tokyo (JP)

(21) Appl. No.: 17/195,314

(22) Filed: Mar. 8, 2021

Related U.S. Application Data
(60) Provisional application No. 62/986,383, filed on Mar. 6, 2020.

(51) Int. Cl. G06Q 10/00; G06Q 30/02; G06K 19/06; B65D 5/62

(52) U.S. Cl. CPC G06Q 10/30; B65D 5/62; G06K 19/06046; G06Q 30/0224

(57) ABSTRACT

A packaging material tracking system 1 for encouraging the reuse of packaging material, the system being characterized by comprising: packaging material information databases 8-10 in which information for the packaging material 3 is stored by a computer in association with attributes 19 of the packaging material 3, a tracking code 18 appended to the packaging material 3, and initial provider 23 and reusing owner history information 21 for the packaging material; an owner determination unit 12 that, when the computer receives attributes and a tracking code 18 for packaging material 3 inputted by a current owner of the packaging material, and information for packaging material matching the combination of attributes and code is present in the databases 8-10, determines the inputter as the current owner of said packaging material; and a reuse history updating unit 13 by which the computer saves the current owner in the database, and updates the initial owner and reusing owner history information.

### BACKGROUND OF THE INVENTION

Wrapping is an essential decorative element when sending gifts. Not only is a beautifully wrapped gift pleasing to the eye of the recipient, but the choosing of colorful wrapping paper and ribbons is also a pleasure for the giver.

Since ancient time, gifts in Japan have been carefully wrapped in Japanese washi paper. The Japanese art of wrapping, in which so much care is put into the final effect, is truly an expression of omotenashi, the Japanese spirit of hospitality and etiquette, and has been acclaimed internationally for its visual beauty, artful wrapping techniques, and creativity. Moreover, as a result of the deep-seated Japanese mentality of treating everyday objects with respect, combined with the prevalence of naname-ori, a wrapping technique in which the paper only needs to be taped in one place, wrapping paper is often carefully removed so that it can be reused.

### PROBLEM TO BE SOLVED BY THE INVENTION

Meanwhile, there are many occasions for sending gifts, such as birthdays and anniversaries, with large quantities of wrapping papers being used each time.

This presents the following problems.

Putting effort into choosing a beautiful design, only for it to be ripped up in an instant when the gift is opened.

The impact on the environment of using and throwing away large quantities of wrapping paper and tape.

Gift-wrapping paper is often subjected to special processes, such as lamination, making it difficult to recycle.

### PURPOSE OF THE INVENTION

The present invention was conceived in view of the circumstances described above, and has an object of providing a reusable gift wrapping paper that strike a balance between beautiful Japanese-style wrapping and reduced environmental impact.

### MEANS FOR SOLVING THE PROBLEM

(1) A wrapping paper tracking system for encouraging the reuse of wrapping paper, the system comprising:

a wrapping paper information database, wherein information for the wrapping paper is stored in association with attributes of the wrapping paper, a tracking code appended to the wrapping paper, and initial owner and reusing owner history information for the wrapping paper;

an owner determination unit configured to receive attributes and a tracking code for wrapping paper inputted by a current owner of the wrapping paper, and determine the inputter as the current owner of said wrapping paper if information for wrapping paper matching a combination of the attributes and tracking code is present in the database;

a reuse history updating unit configured to save the current owner in the database, and updates the initial owner and reusing owner history information; and

a reuse reward information display unit, wherein information on rewards for reusing the wrapping paper is displayed to the current owner when the owner determination unit has determined the current owner.

### EFFECTS OF THE INVENTION

The features described above make it possible to track information associated with wrapping paper, and to provide incentives for reusing the same.

An embodiment of the present invention will now be described with reference to the drawings.

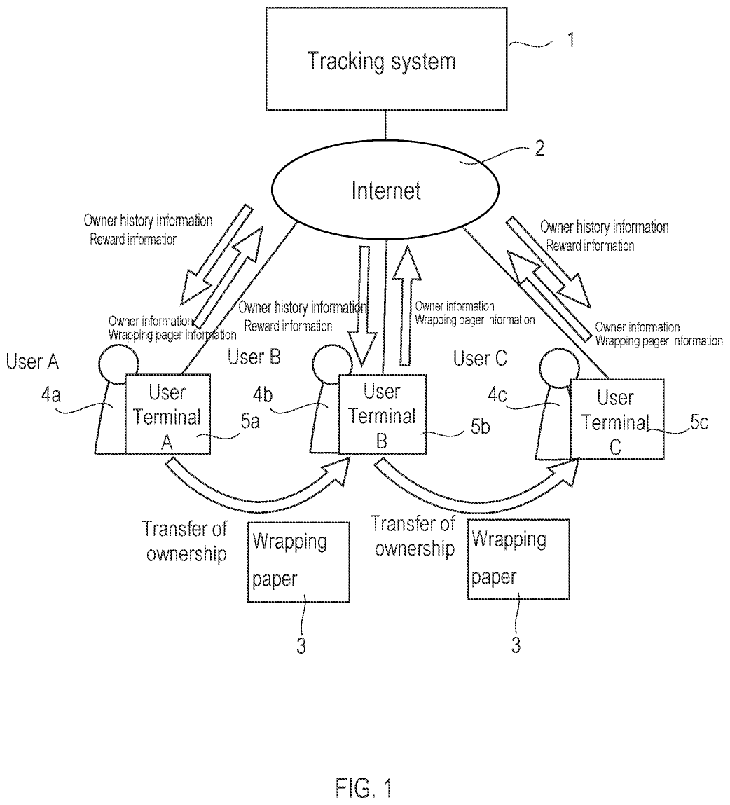

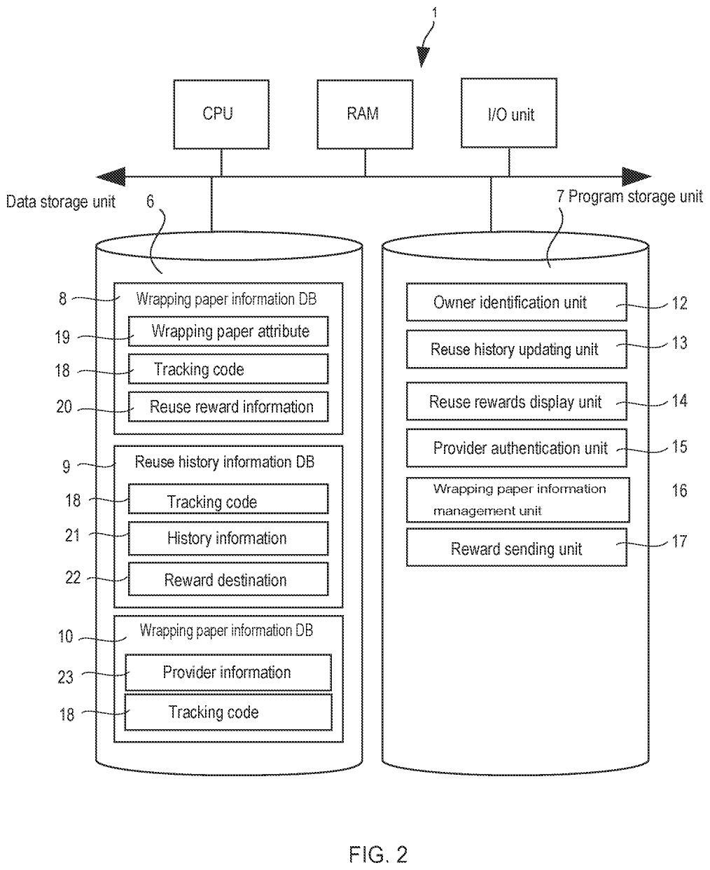

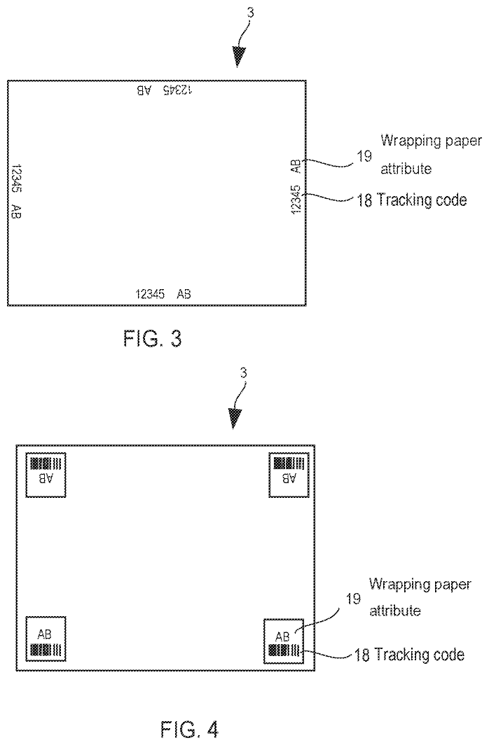

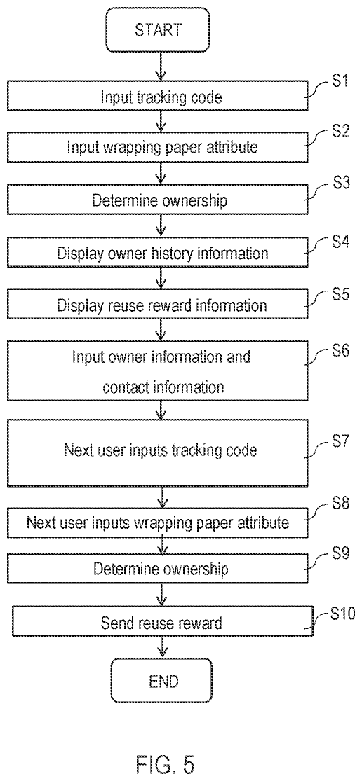

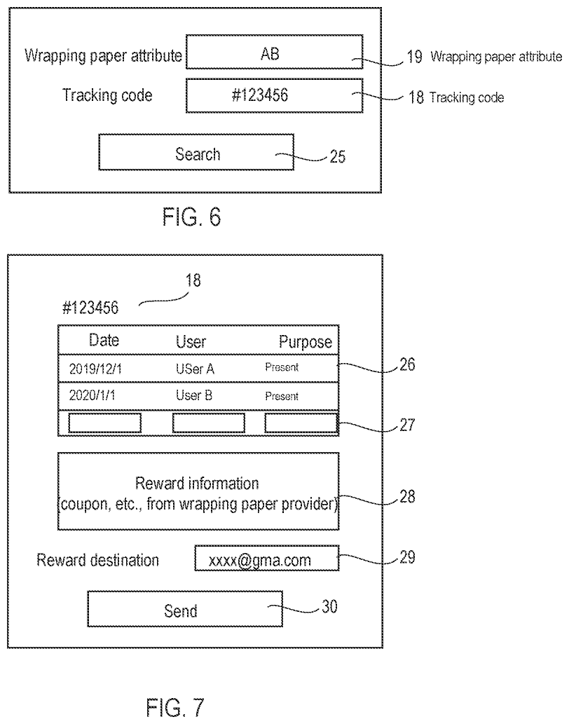

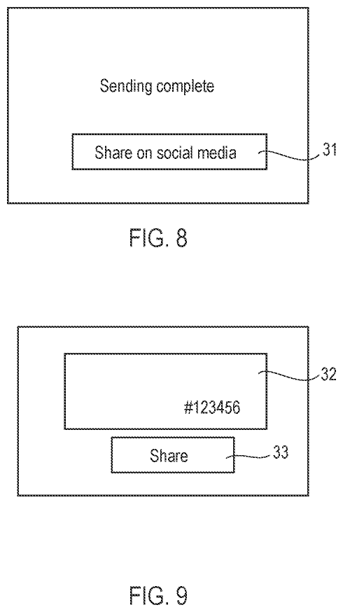

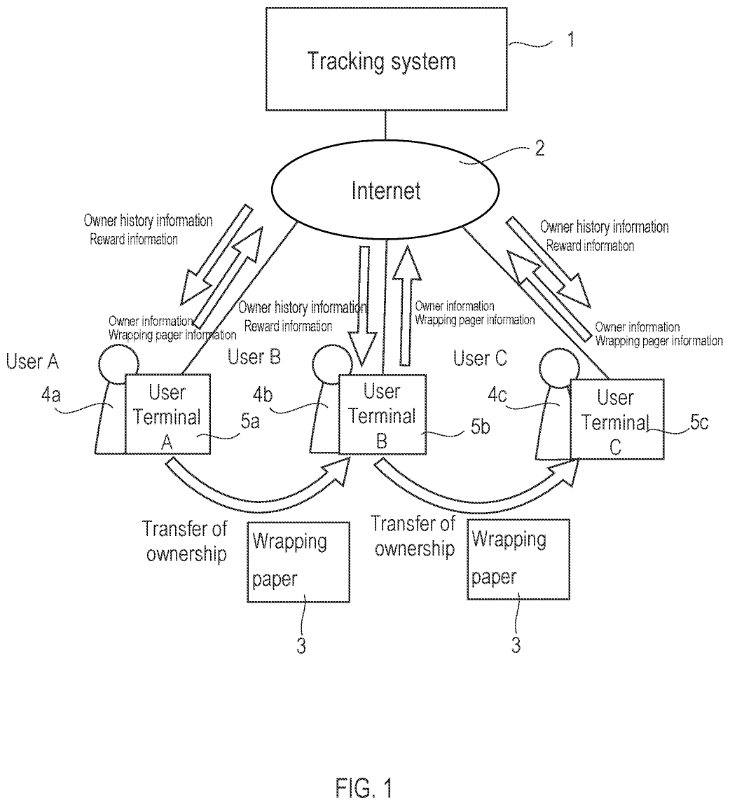

FIG. 1 illustrates the schematic configuration of this embodiment.

### OVERALL CONFIGURATION

In FIG. 1, reference number 1 indicates a tracking system according to an embodiment of the present invention.

The tracking system 1 is capable of communicating with a smart phone 5 of a user 4 of wrapping paper via the Internet 2. 4a indicates an initial user of the wrapping paper, 4b a second user, and 4c a third user.

The initial user is typically the provider of the wrapping paper. For example, if a given retailer is the provider, and uses the wrapping paper to wrap a product sold to user B, ownership of the wrapping paper transfers to user B.

If the wrapping paper is for sale, the initial owner, i.e., the provider, may be the purchaser of the wrapping paper from the manufacturer or a vendor of the wrapping paper. In such cases, ownership transfers to user B when the initial user uses the wrapping paper to wrap a present for user B.

The tracking system 1 provides an environment that encourages reuse of the wrapping paper in such circumstances.

(Tracking System)

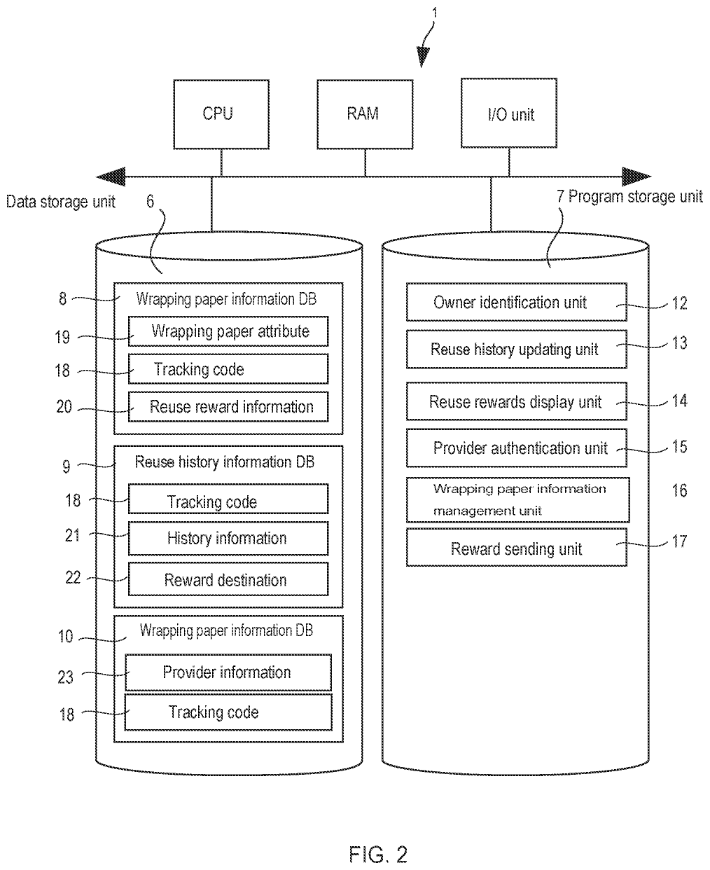

FIG. 2 is a system configuration diagram of the tracking system 1.

In this system, a data storage unit 6 and a program storage unit 7 are connected to a communication bus 5 to which a CPU 2, RAM 3, and an I/O interface 4 are connected.

To limit the discussion to the parts relevant to the present invention, a wrapping paper information database 8, a reuse history information database 9, and a wrapping paper provider database 10 are stored in the data storage unit 6.

To limit the discussion to the parts relevant to the present invention, an owner determination unit 12, a reuse history updating unit 13, a reuse rewards display unit 14, a provider authentication unit 15, a wrapping paper information management unit 16, and a reward sending unit 17 are stored in the program storage unit 7.

The wrapping paper information database 8 stores an attribute of the wrapping paper and reward information 20 that is provided when the wrapping paper is reused in association with a tracking code of the wrapping paper.

The reuse history information database 9 stores information 21 on reusing owners and a reward destination 22 in association with the tracking code.

Wrapping paper provider information 23 and the tracking code appended to the wrapping paper provided by the wrapping paper provider are stored in association with each other in the wrapping paper provider database 10.

The owner determination unit 12 receives an attribute and a tracking code for wrapping paper inputted by the current owner of the wrapping paper, and, if information for wrapping paper matching the combination of attribute and code is present in the database 8, determines the inputter as the current owner of the wrapping paper.

The reuse history updating unit 13 saves and updates information for the current owner in the database, saves and updates history information for the initial owner and reusing owners (users), and displays the updated information on the users smart phone.

When the history information 21 is displayed, the reuse rewards display unit 14 displays the reuse reward information 20 on the user terminals.

The provider authentication unit 15 authenticates the wrapping paper provider who is the initial owner of the wrapping paper.

The wrapping paper information management unit 16 permits the authenticated provider to register and edit the wrapping paper information and reward information.

The reward sending unit 17 sends the reward information to the destination 22 for the user who used the wrapping paper.

The configuration and operation of the various constituent units 12-16 in the course of a method of encouraging reuse of the wrapping paper using the system 1 will now be described.

(Wrapping Paper)

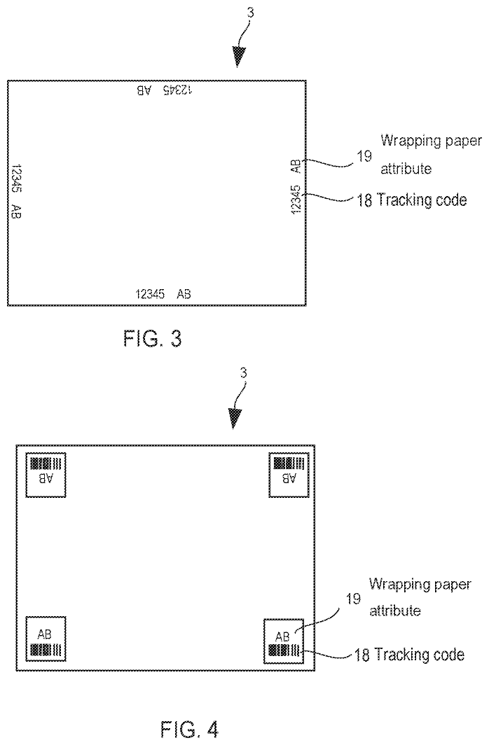

FIGS. 3 and 4 illustrate wrapping paper according to this embodiment.

The wrapping paper in this embodiment is strong enough to withstand reuse, and is also, for example, durable and water-resistant, and is preferably untearable Tyvek® or recycled synthetic paper such as Yupo, or long-fibered nonwoven fabric, washi, or the like, though not limited thereto.

As a rule, the wrapping paper preferably has a simple design not limited to any purpose, but may be printed with a desired design if ordered by a sponsor corporation.

In this embodiment, masking tape may be provided as tape suitable for use with the wrapping paper. The masking tape preferably has a design that harmonizes with the wrapping paper, and does not leave residue behind when removed.

In this embodiment, a guide on how to perform wrapping is preferably offered online by the system 1.

A kit combining the abovementioned masking tape and guide, as well as scissors, etc., with the wrapping paper into a set may also be sold.

(Tracking Code)

In this embodiment, the tracking code is printed directly on the wrapping paper (FIG. 3) or provided in the form of a label (FIG. 4).

The tracking code may be a serial number, or randomly generated numbers or symbols.

The tracking code may also be provided as a barcode or a QR code.

The tracking code is appended to the wrapping paper; in this case, preferably at one or more locations.

In this embodiment, the tracking code is, for example, printed along the four edges as shown in FIG. 3. Alternatively, labels may be applied to the four corners, as shown in FIG. 4.

(Provision of Wrapping Paper)

In this embodiment, the wrapping paper is sold/provided online or at a retail establishment.

If the wrapping paper is sold online, the wrapping paper information management unit 16 may be configured to receive an order to manufacture wrapping paper from an initial owner.

In such cases, the wrapping paper information management unit 16 is configured to allow the corporation ordering the wrapping paper (i.e., the provider of the wrapping paper) to select the desired design and input other required wrapping paper information through an interface displayed on a terminal 5 of the user. In such cases, the wrapping paper information management unit 16 may be configured to allow the provider to input the reward information.

If the provider is an individual, it is possible to offer a discount off the retail price (sponsorship) by outputting advertisements or rewards (reward information) for another corporation.

When ordering the wrapping paper, or after the wrapping paper has arrived, the orderer inputs information 23 about the orderer, in addition to the attribute of the wrapping paper and the tracking code appended to the wrapping paper, in the wrapping paper database as provider information, thereby being registered as the initial owner (provider).

If the wrapping paper is sold as a retail establishment, the wrapping paper is preferably provided in the form of a kit, as described above. In such cases, the wrapping paper is purchased at the retail establishment, and the party for whom owner information 23 is registered in the databases 8, 10 along with the attribute of the wrapping paper and the tracking code appended to the wrapping paper becomes the initial owner (provider).

(Inputting Tracking Code)

Next, a reuse tracking process using this wrapping paper will be described using the flowchart of FIG. 3.

This process assumes that the wrapping paper has been provided to a user B by the initial owner (user in FIG. 1), and the user B has reused the wrapping paper in a present given to another user C.

The step reference numbers S1 through S in this flowchart correspond to the reference numbers for the various steps in the following description.

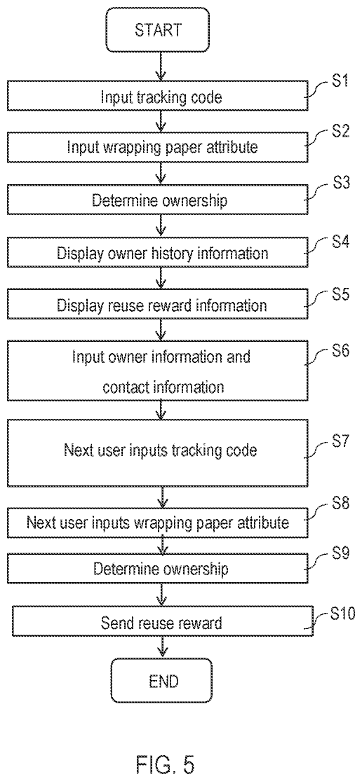

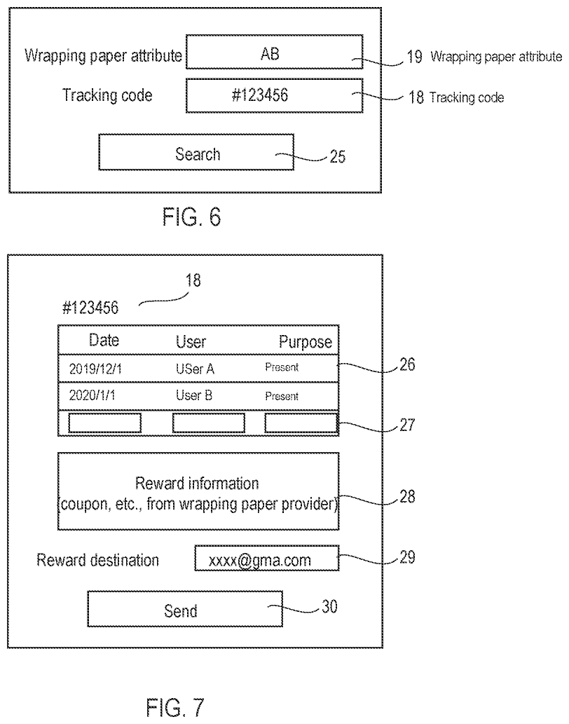

FIG. 6 illustrates an example of an interface displayed by an application (including a web application) installed on a terminal 5b of user B.

In this figure, user B inputs an attribute and a tracking code for wrapping paper received by the user to retrieve the history of the wrapping paper (steps S1, S2).

If information matching the tracking code and attribute is found, user B is confirmed as having ownership of the wrapping paper, and the screen depicted in FIG. 7 is displayed (step S3).

In this interface, the history information 21 is displayed along with the tracking code (step S4). In this interface, a reward information display field 28 for displaying reward information 20 as an incentive to reuse is displayed (step S5). The reward stated in the reward information 20 is, for example, a coupon offered by, for example, the provider of the wrapping paper. In this interface, the current owner can input contact information. This ensures that a reward is delivered when the next user reuses the wrapping paper.

Examples of reward information include services from a sponsor corporation, and coupons or points that can be used to purchase products. Alternatively, the sponsor corporation may donate to environmental conservation organizations according to the number of times the wrapping paper has been reused.

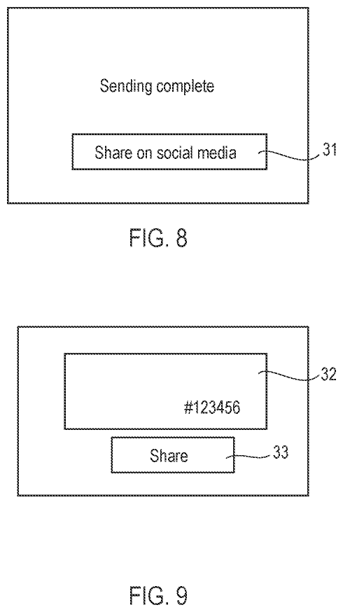

When inputs date, name, and purpose information and contact information are input into this interface and pushes a send button 30 (step S6), the information is stored in the storage unit, and the interface shown in FIG. 8 indicating that sending is complete is displayed.

(Sharing Information)

This sending complete interface has a share on social media button.

When the share on social media button 31 is pressed, a social media sharing interface such as illustrated in FIG. 9 is opened, with the tracking code pre-entered as a tag in an input field 32 on the interface.

The user can thus input information or upload images into the input field to post to social media.

(Providing rewards upon confirmed reuse)

Next, assume that user B reuses the wrapping paper in a present given to user C. In such a case, user B notifies user C that the wrapping paper is reusable. This reward serves as an incentive for further reuse.

Next, user B searches using the tracking code and attribute of the wrapping paper (steps S8, S9), and, if ownership is confirmed (step S9), the reward sending unit 17 sends reward information to the previously inputted contact information for user B. As described above, the reward information is, for example, a coupon code or other incentive for products or services offered by the provider.

While an embodiment of the present invention has been described above, the present invention is not limited thereto. It goes without saying that various modifications may be made which are encompassed within the spirit of the invention.

1. A wrapping paper tracking system for encouraging the reuse of wrapping paper, the system comprising:
a wrapping paper information database, wherein information for the wrapping paper is stored in association with attributes of the wrapping paper, a tracking code appended to the wrapping paper, and initial owner and reusing owner history information for the wrapping paper;
an owner determination unit configured to receive attributes and a tracking code for wrapping paper inputted by a current owner of the wrapping paper, and determine the inputter as the current owner of said wrapping paper if information for wrapping paper matching a combination of the attributes and tracking code is present in the database; and
a reuse history updating unit configured to save the current owner in the database, and updates the initial owner and reusing owner history information.

2. The system according to claim 1, further comprises:
a reuse reward information display unit, wherein the computer displays information on rewards for reusing the wrapping paper to the current owner when the owner determination unit has determined the current owner.

3. The wrapping paper tracking system according to claim 2, wherein:
the wrapping paper information is associated with information on a provider of the wrapping paper; and
the system comprises:
an owner verification unit configured to verify the initial owner; and
a wrapping paper information management unit configured to permit registration and editing of the wrapping paper information and reuse reward information in response to the verification.

4. The system according to claim 2, wherein:
the computer further comprises a reward sending unit, wherein a reward identified by the reward information is sent to contact information designated by a previous owner of the wrapping paper when the wrapping paper is reused; and the reuse reward information display unit comprises a destination input unit which enables to input a destination for the reward into the computer.

5. An application used in the system according to claim 1, the application being characterized by comprising:
a tracking code input unit by which the computer receives attributes and a tracking code for wrapping paper inputted by the current owner of the wrapping paper; and
a wrapping paper history display unit on which the computer displays the initial owner and reusing owner history information.

6. The application according to claim 5, which is characterized by having a sharing means for sending the above tracking code to an SNS application and displaying it together with a tag symbol in a posting column.

7. A wrapping paper optimized for use in the system of claim 1, which has a wrapping paper body and a tracking code attached to the wrapping paper body, wherein attributes of the wrapping paper, the tracking code, and history information about the owner are registered in a database.
